(19) United States
(12) Patent Application Publication
(10) Pub. No.: US 2006/0068691 A1
(43) Pub. Date: Mar. 30, 2006

(54) Abrading tools with individually controllable grit and method of making the same

(75) Inventors: Chien-Min Sung, Tansui (TW); Frank S. Lin, Taipei (TW); Yang-Liang Pai, Taipei City (TW)

Correspondence Address: THORPE NORTH & WESTERN, LLP., 8180 SOUTH 700 EAST, SUITE 200, SANDY, UT, 84070, US

(73) Assignee: Kinik Company

(21) Appl. No.: 10/953,885

(22) Filed: Sep. 28, 2004

(51) Int. Cl. B23F 21/03

(52) U.S. Cl. 451/540

(57) ABSTRACT

A replaceable superabrasive tool insert for use in an abrading tool body includes an attachable shank, having a working end and an attachment end. At least one superabrasive particle is individually attached to the shank at the working end of the shank to provide an abrading interface between the shank and a work piece to be abraded. The attachment end of the shank is configured to be removably attached to the abrading tool body.

### FIELD OF THE INVENTION

The present invention relates generally to abrading tools. More particularly, the present invention relates to abrading tools having a controlled placement of individual superabrasive particles for use in machining and finishing processes.

### BACKGROUND OF THE INVENTION

Diamond tools are used in a variety of machining processes and applications such as cutting, drilling, sawing, grinding, polishing, etc. Such tools can take many different geometrical forms such as rods, plates, and wheels. Many of these diamond tools contain a multitude of diamond grits which can be attached to a substrate in a variety of manners, including: bonding with an organic material (e.g., epoxy or resin); electro-deposition with nickel; sintering with an alloy (e.g., cobalt, iron, or bronze); or by brazing with an alloy (e.g., nickel or copper based alloys).

One of the more commonly used diamond tools is a hand-held “dresser” which may contain one or several diamond crystals on a working surface. The dresser is commonly used for dressing, or cleaning and sharpening, various grinding and polishing wheels, which often become dull after use. This dulling is caused by both the accumulation of ground dust between abrasive grains and also to the erosion, or flattening, of the top of the abrasive grains themselves. During the dressing process, the diamond dresser is pressed against the worn grinding or polishing wheel or pad that contains the underexposed abrasive. The diamond crystals on or in the dresser serve to clean out the matrix of the grinding wheel to expose the abrasive particles. In this manner, the grinding wheel is “sharpened” for further work.

Many conventional hand-held dressers are made by attaching diamond on the tip of a rod. When the diamond is worn out, the entire rod is generally discarded. Also, since diamond is notoriously difficult to firmly attach, conventional dressers often use an oversized natural diamond and submerge the base of the natural diamond within a sinterable metal powder. The powder is then sintered to form a consolidated mass, thereby mechanically affixing the diamond in place. While the diamond is generally firmly affixed in place with this method, only the very small portion of the diamond tip can generally be used for dressing. Often, when the diamond tip is worn flat, the entire tool is discarded. This practice is undesirable for a number of reasons. First, because affixing the diamond particles in place is often difficult, it is often the case that firm, small synthetic diamond grits (typically less than 0.01 carat per piece) cannot be effectively used. Generally only large natural diamond (0.1-0.3 carat) may be used with consistent success. This can result in a much higher cost associated with producing the dressers. Second, when the diamond tip becomes flattened, or dull, even if only worn relatively low, the entire tool must generally be discarded.

Hand held dressers may also contain a multitude of diamond grits, in which case it may be possible to use synthetic diamond particles. However, these particles are collectively also embedded in a sintered metal matrix. Although more grit particles may be used to dress a tool, the results often also prove unsatisfactory for similar reasons. Because the grit particles are often not firmly affixed in place, they cannot be exposed sufficiently above the binding matrix to ensure active dressing (i.e., the grit may be dislodged as it becomes more fully exposed above the binding matrix). As a consequence, the dressing process is often slow and laborious.

Conventional grinding wheels have also been made by embedding a plurality of diamond grits in the periphery region of a round tool. During normal use, as the diamond grit particles become worn, the frictional force between the tool being ground and the particles increases, causing the particles to be prematurely dislodged from the wheel. Subsequently, new layers of diamond will be exposed to continue the work. This design suffers from similar shortcoming as the dressing tool discussed above. Because diamond grit particles are generally not firmly attached, a significant portion of the particles cannot be exposed to perform aggressive grinding work. If a significant portion of each particle is exposed, the particles can become much more easily dislodged.

Grinding wheels have been produced that contain a single layer of diamond that is attached to the base metal by either electroplating with nickel or brazing with an alloy. Although such tools can cut aggressively, they are short lived due to the lack of additional layers that could otherwise be used to do additional work once the layer of diamonds is dislodged. When such a tool becomes overly worn, the entire grinding wheel is generally discarded.

In addition, mechanical polishing and chemical mechanical planarization (CMP) are commonly used for making advanced components that require high surface flatness and finish. With the miniaturization of electronic and optical systems, such highly polished surfaces are in even greater demand. Hard drives must often be polished to allow a rapidly moving read head to travel at very narrow “flying gap.” Also, modern semiconductors generally require extremely flat surfaces for precision photolithographic processing.

In order to obtain these very flat and finished surfaces, conventional polishing systems have been developed that contain a rotating platen. A polyurethane pad is often placed on top of the rotating platen. The work piece (e.g., a silicon wafer) is compressed against the polishing pad and both the work piece and pad rotate in the same direction. A stream of slurry is fed onto the pad and is carried around by the pad. The polishing of the work piece takes place when the slurry is squeezed between the work piece and the pad.

During the polishing process, the debris removed from the work piece and the “shred” cut from the pad often mix to form a paste that may disadvantageously cover, or “coat” the pad surface. The coated region will become hard (known as glazing) and it may no longer hold the slurry. Worse still, the glazed area will have a decreased friction so it can no longer polish the work piece effectively. As a consequence, the polishing rate of the work piece will gradually decline (about 1% per wafer). Hence, a typical new pad may be effectively used to grind only about 50 wafers before it has to be replaced. Because the polishing life of the pad is limited, the costs of the process will increase and the throughput will decrease.

For these reasons, it has been contemplated to use a dresser to dress, or clean, the pad to remove the debris and the “shred” produced during polishing. In addition to cleaning the pad surface, the dresser can groove or slot the pad surface to allow thicker slurry to be moved away from the abrading surface. However, typical diamond dressers have also proved limited in effective use in dressing CMP pads. For example, there are a number of ways in which a multitude of diamond grit particles can be attached to a base plate (e.g., made of stainless steel). There are at least two common ways of attaching diamond to a CMP pad dresser. One way is to embed diamond with electro-deposited nickel (similar, for example, to products made by Asahi of Japan). Another way is to surround diamond with sintered metal powder (similar to products made by 3M of the USA). However, it has been found that both of these processes will inevitably result in a high loss of diamond particles during the dressing process. This is generally highly undesirable, as the detached diamond particles can easily scratch expensive work pieces.

Conventional diamond dressers suffer another drawback in that all of the diamond grit particles are often distributed randomly. That is, the height of the diamond particles below the dresser can vary greatly, with some particles extending further from the dresser than others. As a result, the grooving pattern on the polishing pad can be very uneven or inconsistent, as some particles will be grinding the pad while others don't contact the pad. An uneven or inconsistent grooving pattern can result in reduced polishing rate which can result in under- or over-polishing of the work piece. Under-polishing can result in low production yield, and over-polishing can result in a high rework rate. In addition, in a randomly distributed diamond dresser, the isolated grits will receive a higher dragging force, making them more prone to be dislodged by grinding forces. Again, dislodged particles can result in scratched work pieces, which can often be very expensive.

### SUMMARY OF THE INVENTION

It has been recognized that it would be advantageous to develop an abrasive tool and associated methods that provide interchangeable and replaceable abrading grit particles. It has also be recognized that it would be advantageous to develop an abrading tool in which the abrading particles are evenly dispersed relative to an underlying work piece to increase the effectiveness and useful life span of the abrading tool.

Accordingly, the present invention provides a replaceable superabrasive tool insert for use in an abrading tool body, including an attachable shank having a working end and an attachment end. At least one superabrasive particle can be individually attached to the shank at the working end of the shank to provide an abrading interface between the shank and a work piece to be abraded. The attachment end of the shank can be configured to be removably attached to the abrading tool body.

In accordance with a more detailed aspect of the present invention, a superabrasive tool for use in abrading a work piece is provided, including an abrading tool body and at least one replaceable tool insert. The tool insert can include an attachable shank, having a working end and an attachment end, and at least one superabrasive particle, individually attached to the shank at the working end of the shank. The at least one superabrasive particle can provide an abrading interface between the shank and the work piece and the at least one insert can be removably attached to the abrading tool body.

In accordance with a more detailed aspect of the invention, a method for forming a superabrasive tool for use in abrading work pieces is provided, including the steps of: providing a plurality of shanks, each shank having: a working end having at least one superabrasive particle attached thereto; and an attachment end; and removably coupling the attachment end of each of the plurality of shanks to a tool body such that a distance between a tip of each superabrasive particle and the tool body is defined.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic, sectioned side view of a tool insert having a superabrasive particle attached thereto in accordance with an embodiment of the present invention;

FIG. 2 is a schematic, sectioned side view of the tool insert of FIG. 1 attached to or in a tool body;

FIG. 3 is a partial schematic, sectioned side view of another tool body and tool insert in accordance with the present invention;

FIG. 4 is a schematic, sectioned side view of another tool body and tool insert in accordance with the present invention;

FIG. 5 is a schematic, sectioned side view of another tool body and tool insert in accordance with the present invention;

FIG. 6 is a schematic top view of an abrading tool body in accordance with the present invention; and

FIG. 7 is a schematic, sectioned side view of an alternate tool body having tool inserts being leveled with a leveling plate in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As a preliminary matter, the present invention is directed to abrading tools utilizing superabrasive grits or particles which can be of relatively small size, e.g., on the order of 400 U.S. mesh in some cases. Such abrasive particles or grits are generally much smaller than bodies of abrading tools in connection with which they are used, e.g., grinding wheels, grinding wheel dressers, dressing pads, etc. For this reason, the figures included herein schematically illustrate the diamond particles or grit in relation to other components, with accuracy of scale ignored in the interest of simplicity. Similarly, in those embodiments in which the particles or grit are shown bonded or otherwise attached to a body, the portions of braze, solder or epoxy are shown schematically and do not necessarily accurately depict the position of the solder, braze or epoxy relative to the dimensions of the grit or particle.

As used herein, the term “superabrasive particle” is to be understood to mean a particle of grit that possesses sufficient hardness to be used to abrade, wear, or score a work piece. Examples of superabrasive particles include, without limitation, diamond and diamond grit particles, synthetic diamond and synthetic diamond grit particles, cubic boron nitride particles, etc.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 micrometer to about 5 micrometers” should be interpreted to include not only the explicitly recited values of about 1 micrometer to about 5 micrometers, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described

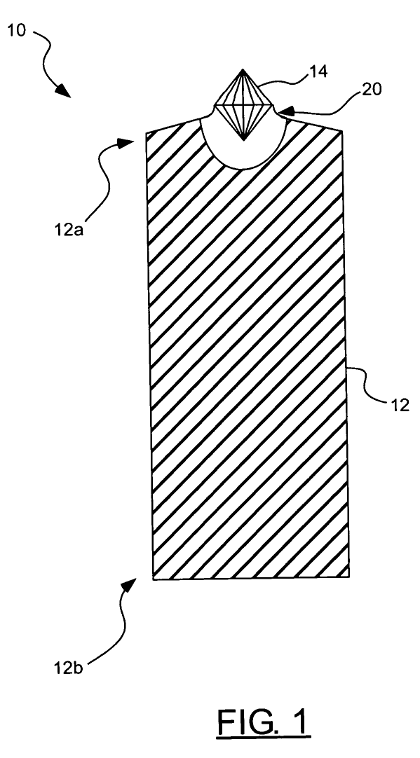

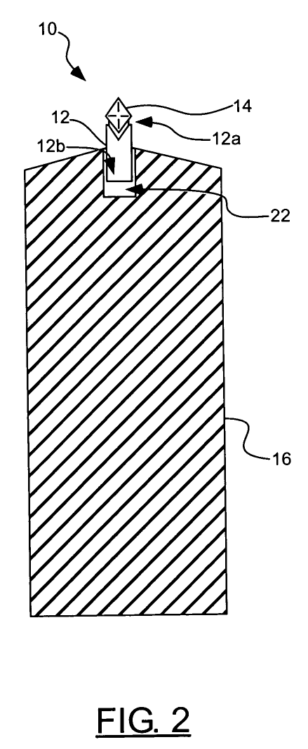

As illustrated in FIG. 1, a tool insert, indicated generally at 10, is provided in accordance with the present invention. The tool insert can include an attachable shank 12, which can have a working end 12a and an attachment end 12b. At least one superabrasive particle 14 can be individually attached to the shank at the working end of the shank. The superabrasive particle can provide an abrading interface between the shank and a work piece (not shown) to be abraded by the tool insert. In the embodiment shown, the attachment end 12b of the shank can be configured to be removably attached to an abrading tool body (e.g., hand-held dresser 16 in FIG. 2). The present invention thus provides a superabrasive tool insert that can be removably attached to a tool to provide an adjustable abrading interface between the tool and the work piece to be abraded.

The insert 10 can be advantageously utilized in a variety of abrading tools, including dressers, grinding wheels or pads, abrading pads, chemical mechanical planarization (“CMP”) pads, etc. In use, one or more of the inserts can be coupled to the abrasive tool to provide an abrasive interface between the tool and a work piece. As discussed in more detail below, the insert provides several advantages, including the ability interchange or replace an individual particle of an abrading tool in the event the particle becomes overly worn or damaged. In addition, a relative distance between each superabrasive particle and the abrading tool can be adjusted to accurately align a plurality of the particles relative to the work piece being abraded. In this manner, the abrading “surface” (e.g., the portion of the abrading tool that contacts and abrades the work piece) of the tool can be much more carefully controlled as compared to conventional abrading tools. By more carefully controlling the abrading “surface,” unwanted damage to the work piece can be avoided while increasing the speed and quality of the abrading process.

The tool insert 10 shown in FIG. 1 can be used in a variety of applications. In one embodiment of the invention, the tool insert can be used in combination with other articles, for example as the abrading element of a tool dresser, such as that shown by example at 16 in FIG. 2. In this aspect of the invention, the tool insert is generally used to remove unwanted material from work pieces that can also be abrading tools, such as grinding wheels (not shown). Conventional grinding wheels often become less effective, or “dull,” due to material becoming accumulated between abrading particles on the grinding wheel, or due to wear of the abrading particles themselves. In this case, the present invention can advantageously be used to “dress” the grinding wheel or other tool and condition the wheel for further use.

The superabrasive particles 14 can be individually attached to a shank 12 or other member. As used herein, the term “individually attached” is to be understood to refer to a condition in which the particle or particles are attached to the shank independently of other particles. Thus, in this aspect of the invention, the particles are not attached to the shank as an aggregate, such as is the case with a PCD or other aggregate mass. In the embodiment shown in FIG. 1, one superabrasive particle 14 is attached directly to the working end 12a of the shank 12.

The superabrasive particle 14 can be individually attached to the shank in a number of manners. In one aspect, the superabrasive particle is attached to the shank by a braze alloy 20 which can include a base component or member such as nickel, cobalt, copper and/or mixtures thereof. Thus, in this aspect, the superabrasive particle, which can be diamond or synthetic diamond, can be attached to the shank with a molecular bond. Such a bond is generally much stronger than conventional electro-deposition or sintering that employ mechanical force to maintain the diamond particle. Because such a braze can be provided as substantially fully molten, it can wet the diamond particle to provide substantially full diamond-to-alloy contact.

The braze 20 can also include an active element or component which can react with the diamond particle to form carbides that bond the diamond particles 14 to the shank 12 at an atomic level. The active element can include, without limitation, titanium, chromium, manganese, vanadium and/or silicon, in varying proportion to the base braze material. In one aspect of the invention, the braze can include at least 2% by weight of the active element.

One advantage to using a braze alloy to bond the diamond particles is that smaller superabrasive particles can be utilized. For example, synthetic diamond particles of less than 0.01 carat have been successfully used. As shown schematically in FIG. 1, even very small diamond or abrasive particles 14 can be attached to the shank 12 yet still protrude relatively far beyond the working end 12a of the shank. In this manner, the individual diamond particle or particles can be used to dress or polish work pieces without becoming “gummed” up or submerged by debris from the work piece.

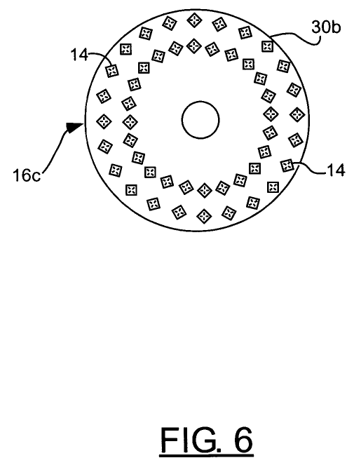

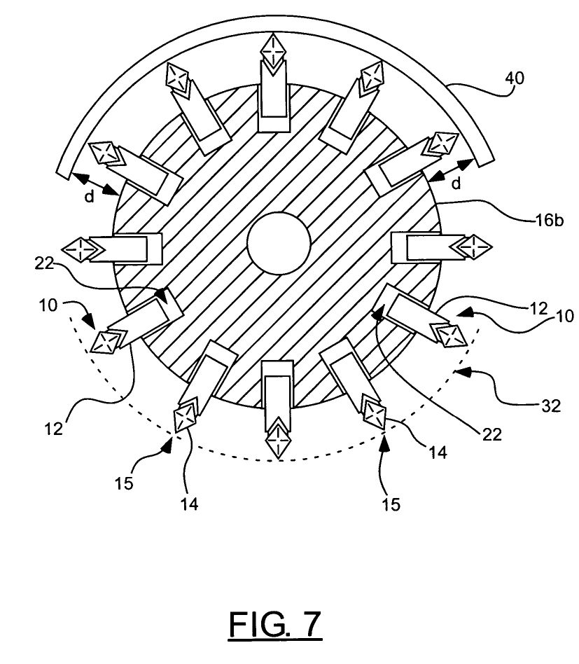

Once the superabrasive particle 14 is attached to the shank 12, the shank can be attached to or inserted within a tool body, such as hand-held dressing tool 16 illustrated in FIG. 2. In this embodiment of the invention, the particle 14 of the hand-held dresser can be placed against a grinding wheel or other abrading work piece that has become “dull,” either due to blunting of the abrasive material of the wheel or due to accumulation of debris within the wheel. In either case, the wheel can be turned while the particle 14 is held adjacent the wheel to sharpen the abrasive material of the wheel, to clean debris from the material, or a combination of both. As will be appreciated, the tool insert 10 can be inserted into or attached to a variety of tools, such as grinding wheel 16b shown schematically in FIG. 7, or dressing pad 16c shown schematically in FIG. 6. The tool insert 10 can generally be used with a variety of types of abrasive tools that can benefit from individually adjustable superabrasive particles. Other examples of superabrasive tools with which the insert can be used include CMP pad dressers, cylindrical dressers, etc. With each of these types of tools, if the superabrasive particle becomes damaged or overly worn, the tool insert can simply be removed from the tool body and easily be replaced with another insert and particle.

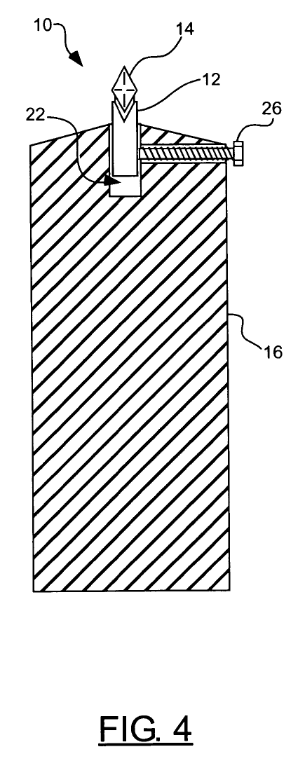

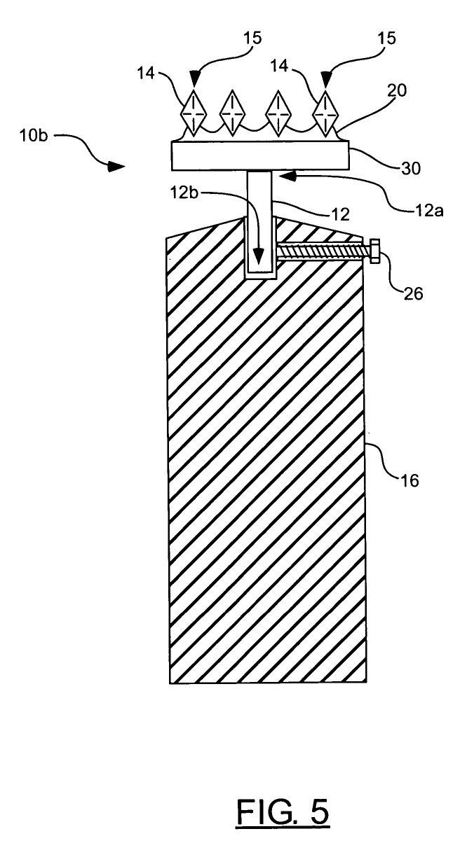

The attachment end 12b of the tool insert 10 can be removably coupled to the tool body 16 in a variety of manners. As shown by example in FIG. 2, the tool insert 10 can be inserted into receiving slot or notch 22 and can be bonded, welded or otherwise secured onto or within the slot or notch. The insert can also be mechanically interlocked within the slot or notch via methods known to those in the art, for example with set screw 26 shown in FIGS. 4 and 5. Other attachment methods include interference fitting, thermally induced interference fitting, organic binder adhesives such as epoxy, soldering with material such as tin alloy, and combinations thereof. While shank 12 of the tool insert can be formed from a variety of materials, in one embodiment the shank can be formed from a metal. More particularly, the shank can be formed from stainless steel.

The embodiment illustrated in FIG. 1 includes only a single diamond or superabrasive particle 14 attached to the working end 12a of the shank 12. However, as shown by example in FIG. 5, tool insert 10b can include a plurality of superabrasive particles or diamonds 14 attached thereto. While not so required, a receiving member 30 can be disposed intermediate the superabrasive particles and the working end 12b of the shank 12. In this embodiment, the receiving member 30 can be configured to receive and support the plurality of superabrasive particle. As in other embodiments, braze, epoxy or other attachment materials 20 can be used to bond or attach the particles to the receiving member. The number of superabrasive particles or diamonds on the receiving member can vary, and in one embodiment the number varies from two to fifty superabrasive particles. The size of the superabrasive particles can similarly vary, and in one embodiment vary from about 18 to about 400 U.S. mesh in size.

The receiving member 30 illustrated in FIG. 5 can vary in both size and configuration. For example, the receiving member can be formed as a narrow plate with the diamonds or superabrasive particles forming a substantially linear pattern (not shown) as viewed from the top of the insert receiving member. In other embodiments, for example, in the pad dresser 16c of FIG. 6, the superabrasive particles or diamonds 14 can be arranged on a substantially circular receiving member 30b in a circular pattern. As the replaceable tool inserts 10 provide a range of attachment or mounting options, the pattern of attachment of the inserts can be optimized for the application at hand.

FIG. 7 illustrates yet another embodiment of the present invention in which a plurality of tool inserts 10 are coupled to abrading tool body 16b. In this aspect, each diamond or superabrasive particle 14 includes an exposed tip 15. The tips of the particles can collectively define an abrading profile, shown by exemplary profile 32. As will be appreciated, the abrading profile corresponds to the interface between the abrading tool body and the work piece (not shown) which is to be abraded. In the example shown in FIG. 7, the abrading tool body can be a circular grinding wheel or cylindrical dresser that abrades the work piece in a circular, cylindrical or grooved path.

By individually coupling or attaching each of the tool inserts 10 to the tool body 16b, the abrading profile can be tailored to be very precise. For example, each of the tips 15 of the tool inserts can be adjusted such the abrading profile approaches a circle that is “true” to within a predetermined tolerance. In one aspect of the invention, the abrading profile is a circle that is true to within 50 microns, that is, each tip of each diamond particle varies from any other tip by no more than 50 microns. In addition to the circular profile 32 illustrated in FIG. 7, in one aspect of the invention (not shown in the figures) the abrading profile is substantially planar, with each tip of each superabrasive particle being within 50 microns of a common plane.

In addition to the structural aspects of the invention discussed above, the present invention also provides a method for forming a superabrasive tool for use in abrading work pieces. The method can include the step of providing a plurality of shanks, with each shank having a working end having at least one superabrasive particle attached thereto, and an attachment end. The method can also include the step of removably coupling the attachment end of each of the plurality of shanks to a tool body such that a distance between a tip of each superabrasive particle and the tool body is defined. In the example shown in FIG. 7, the tool body 16b includes a substantially rounded curvature and the method includes the step of leveling the superabrasive particles relative to the rounded curvature of the tool body. As used herein, the term “leveling” is meant to include adjustment of the particles relative to each other or another object, and is not limited to leveling with respect to a horizontal plane.

The step of the leveling the particles 14 relative to the tool body 16b can be performed in a variety of manners. In one embodiment, a shank 12 from each of a plurality of disposable inserts 10 can be disposed in a socket 22 formed in the tool body 16b. Each of a tip 15 of each of the plurality of superabrasive particles can then disposed on a leveling plate 40 in order to establish the distance “d” from each particle to the tool body. Each shank can then be fixed relative to the tool body to preserve the distance “d” from each particle tip to the tool body.

The leveling plate 40 is generally only used to level each of the disposable inserts to establish a uniform abrading profile. Once the profile has been established, the leveling plate is generally no longer required, unless and until one or more of the disposable inserts is replaced or repaired. The leveling plate shown in FIG. 7 is generally circular, but can be made to provide a range of profiles, including planar or contoured profiles. The leveling plate can be formed from a variety of materials, including metal or glass. Generally, a variety of materials can be used that are sufficiently stiff to provide a surface on which the tool inserts can be supported while aligning the tool inserts.

By providing a plurality of disposable inserts 10 each having a superabrasive grit or particle 14 associated therewith, the present invention can provide a much more uniform abrading profile between the grits and the work piece than has heretofore been possible. In prior art methods, a quantity of grits has generally been applied across a support surface of an abrading tool and then bonded or otherwise attached to the support surface. The resulting matrix of particles or grit is generally randomly oriented across the support surface and contains particles or grit that often extend above or below many of the other particles. This can result in one or more of the particles gouging the work piece being abraded instead of allowing the matrix to smoothly abrade the work piece. In addition, if one or more particles extend higher above the matrix of particles, the higher extending particle or particles is/are subject to higher stresses imposed by the abrading process, and can be more easily dislodged from the matrix.

The present invention addresses these problems by allowing controlled adjustment of the level of the superabrasive particles relative to the work piece. In addition, as the tool inserts can be attached to the abrasive tool in a variety of patterns, the present invention also provides strategic placement of particles across the face or body of the abrading tool. The resultant pattern of superabrasive particles not only optimizes the abrading process but also reduces the number of particles required, in contrast to conventional methods which may have many layers of diamond buried beneath the “working” layer of particles which are abrading the work piece.

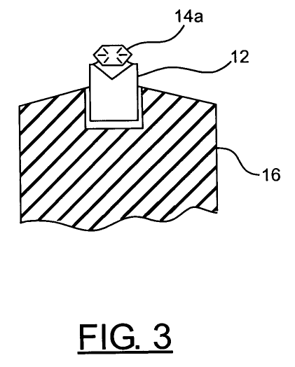

Furthermore, as shown in FIG. 5, the superabrasive particles 14 can be attached to the receiving member 30 while being oriented in a controlled manner. In the embodiment illustrated in FIG. 5, each of the superabrasive particles or grit is oriented such that each tip 15 of the grits is evenly exposed to the work piece (not shown). In the embodiment illustrated in FIG. 3, the superabrasive particle or grit 14a is oriented such that a planar edge of the grit is exposed to the work piece (not shown). It has been found that superabrasive particles, particularly diamond or synthetic diamond particles, exhibit more or less hardness or abrading capability along particular axes of the particle. The present invention allows the diamond particles or grits to be aligned along axes that are optimal for the abrading process for which the abrading tool is designed.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A replaceable superabrasive tool insert for use in an abrading tool body, comprising:
an attachable shank, having a working end and an attachment end; and
at least one superabrasive particle, individually attached to the shank at the working end of the shank, the at least one superabrasive particle providing an abrading interface between the shank and a work piece to be abraded;
the attachment end of the shank being configured to be removably attached to the abrading tool body.

2. The tool insert of claim 1, further comprising a receiving member disposed intermediate the superabrasive particle and the working end of the shank, the receiving member being configured to receive and support the at least one superabrasive particle.

3. The tool insert of claim 2, wherein the receiving member is configured to receive and support a plurality of superabrasive particles.

4. The tool insert of claim 1, wherein the attachable shank is configured to hold only one superabrasive particle.

5. The tool insert of claim 1, wherein the attachable shank is configured to hold from two to fifty superabrasive particles.

6. The tool insert of claim 1, wherein the superabrasive particle is chosen from the group consisting of diamond, cubic boron nitride, and synthetic diamond.

7. The tool insert of claim 1, further comprising a plurality of superabrasive particles from about 18 to about 400 U.S. mesh in size.

8. The tool insert of claim 1, wherein the superabrasive particle is attached to the shank by a braze alloy comprising a member selected from the group consisting of nickel, cobalt, copper and mixtures thereof.

9. The tool insert of claim 8, wherein the braze alloy comprises nickel.

10. The tool insert of claim 8, wherein the braze alloy contains at least about 2% wt of a member selected from the group consisting of titanium, chromium, manganese, vanadium and silicon.

11. The tool insert of claim 1, wherein the attachable shank comprises a metal.

12. The tool insert of claim 11, wherein the attachable shank comprises stainless steel.

13. A superabrasive tool for use in abrading a work piece, comprising:
an abrading tool body; and
at least one replaceable tool insert including:
an attachable shank, having a working end and an attachment end; and
at least one superabrasive particle, individually attached to the shank at the working end of the shank, the at least one superabrasive particle providing an abrading interface between the shank and the work piece;
the at least one tool insert being removably attached to the abrading tool body.

14. The tool of claim 13, wherein the abrading tool body is configured to removably receive a plurality of tool inserts, and wherein tips of the superabrasive particles attached to the plurality of tool inserts define an abrading profile.

15. The tool of claim 13, further comprising a receiving member disposed intermediate the at least one superabrasive particle and the working end of the shank, the receiving member being configured to receive and support the at least one superabrasive particle.

16. The tool of claim 15, wherein the receiving member receives and supports a plurality of superabrasive particles.

17. The tool of claim 13, wherein the abrading tool body is a hand-held dresser.

18. The tool of claim 14, wherein the abrading tool body is a CMP pad dresser.

19. The tool of claim 14, wherein the abrading tool body is a grinding wheel.

20. The tool of claim 14, wherein the abrading tool body is a cylindrical dresser.

21. The tool of either of claims 19 or 20, wherein the tips of the superabrasive particles form a circle that is true to within 50 microns.

22. The tool of claim 14, wherein the abrading profile is a common plane, with each tip of each superabrasive particle being within 50 microns of the common plane.

23. The tool of claim 13, wherein the attachable shank is attached to the superabrasive tool using a method selected from the group consisting of: mechanical locking, interference fitting, organic binder adhesive, soldering and combinations thereof.

24. The tool of claim 23, wherein the organic binder adhesive is an epoxy.

25. The tool of claim 23, wherein the soldering includes a tin alloy solder.

26. The tool of claim 23, wherein the interference fitting includes a thermally induced interference fit.

27. A method for forming a superabrasive tool for use in abrading work pieces, comprising the steps of:
a) providing a plurality of shanks, each shank having:
i) a working end having at least one superabrasive particle attached thereto; and
ii) an attachment end; and
b) removably coupling the attachment end of each of the plurality of shanks to a tool body such that a distance between a tip of each superabrasive particle and the tool body is defined.

28. The method of claim 27, wherein the tool body is substantially flat, and comprising the further step of leveling the superabrasive particles relative to the tool body such that the distance between the tip of each superabrasive particle and the tool body differs by no more than 50 microns from the distance between the tips of the remaining particles and the tool body.

29. The method of claim 27, wherein the tool body includes a substantially rounded curvature, and comprising the further step of leveling the superabrasive particles relative to the rounded curvature of the tool body such that the distance between the tip of each superabrasive particle and the tool body differs by no more than 50 microns from the distance between the tips of the remaining particles and the tool body.

30. The method of claim 27, wherein the step of removably coupling the plurality of shanks to the tool body includes the steps of:
i) disposing each of the plurality of shanks within receiving sockets formed in the tool body;
ii) disposing the tip of each of the plurality of superabrasive particles upon a face of a leveling plate so as to establish the distance from each particle to the tool body; and
iii) fixing each shank relative to the tool body to preserve the distance from each particle tip to the tool body.

31. The method of claim 30, wherein the leveling plate is substantially planar.

32. The method of claim 30, wherein the leveling plate is contoured.

33. The method of claim 30, wherein the leveling plate is formed of a material selected from the group consisting of metal and glass.
